(19) United States
(12) Patent Application Publication
(10) Pub. No.: US 2026/0072235 A1
(43) Pub. Date: Mar. 12, 2026

(54) DISPENSABLE ADHESIVE COMPOSITION FOR AUGMENTED REALITY WAVEGUIDE

(71) Applicant: Applied Materials, Inc., Santa Clara, CA (US)

(72) Inventors: Yingdong LUO, Newark, CA (US); Marco GALIAZZO, Quinto Di Treviso (IT); Neal RICKS, San Jose, CA (US); Gaia FRANDOLI, Olmi di S.Biagio di Callalta (IT); Ludovic GODET, Sunnyvale, CA (US)

(21) Appl. No.: 18/965,384

(22) Filed: Dec. 2, 2024

Related U.S. Application Data
(60) Provisional application No. 63/691,886, filed on Sep. 6, 2024.

(51) Int. Cl. G02B 7/02; C09J 125/06; C09J 133/10; G02B 6/12; G03H 1/00

(52) U.S. Cl. CPC G02B 7/025; C09J 125/06; C09J 133/10; G02B 6/12; G02B 7/021; G02B 2006/12102; G03H 2001/0088

(57) ABSTRACT

In one or more embodiments, a display includes a waveguide. The waveguide includes a substrate with a first surface and a second surface. At least one grating is disposed over the first surface or the second surface. A first lens material is disposed over the first surface of the substrate. A first gap is defined by a lower surface of the first lens material and the first surface of the substrate. A second lens material is disposed over the second surface of the substrate. A second gap is defined by an upper surface of the second lens material and the second surface of the substrate. An adhesive composition includes at least a spacer. The adhesive composition is disposed between the first lens material and the first surface of the substrate, and the second lens material and the second surface of the substrate.

### CROSS-REFERENCE TO RELATED APPLICATIONS

This application claims priority to United States Provisional Ser. No. 63/691,886 , filed Sep. 6, 2024, the entirety of which is herein incorporated by reference.

### BACKGROUND

### Field

Embodiments of the present disclosure generally relate to augmented reality (AR) displays. More specifically, embodiments described herein relate to AR waveguides with attached prescription lens.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality (AR), however, enables an experience in which a user can see through the display lenses of the glasses or other HMD device to view the surrounding environment, yet also see images of virtual objects that are generated to appear as part of the environment. Users that require prescription eye glasses need a prescription lens to clearly see the surrounding environment. Unfortunately, conventional AR devices having prescription eye glasses utilize die and/or laser cut pressure sensitive adhesives (PSAs) or liquid adhesives to attach the substrate to the prescription lens. This can lead to reduced visual inputs and/or clarity due to poor alignment, as well as an increase in stray light entering the AR device. Moreover, these adhesives can fracture and/or degrade during routine use, leading to moisture ingress.

Therefore, what is needed in the art are AR waveguides having enhanced adhesive compositions.

### SUMMARY

Embodiments of the present disclosure generally relate to augmented reality (AR) displays. More specifically, embodiments described herein relate to AR waveguides with attached prescription lens.

In one or more embodiments, a display includes a waveguide. The waveguide includes a substrate with a first surface and a second surface. At least one grating is disposed over the first surface or the second surface. A first lens material is disposed over the first surface of the substrate. A first gap is defined by a lower surface of the first lens material and the first surface of the substrate. A second lens material is disposed over the second surface of the substrate. A second gap is defined by an upper surface of the second lens material and the second surface of the substrate. An adhesive composition includes at least a spacer. The adhesive composition is disposed between the first lens material and the first surface of the substrate, and the second lens material and the second surface of the substrate.

In one or more embodiments, a display, includes a waveguide. The waveguide includes a substrate with a first surface and a second surface. At least one grating is disposed over the first surface or the second surface. A first lens material is disposed over the first surface of the substrate. A first gap is defined by a lower surface of the first lens material and the first surface of the substrate. A second lens material is disposed over the second surface of the substrate. A second gap is defined by an upper surface of the second lens material and the second surface of the substrate. A first adhesive composition and a second adhesive composition are disposed between the first lens material and the first surface of the substrate.

In one or more embodiments, a method for forming a display includes depositing an adhesive composition over a first surface of a substrate of a waveguide, wherein the adhesive composition includes at least a spacer. The method further includes coupling a first lens material to the adhesive composition on the first surface of the substrate, wherein a first gap is formed between the first lens material and the first surface of the substrate. The method further includes depositing a second adhesive composition over a second surface of the substrate of the waveguide and coupling a second lens material to the adhesive composition on the second surface of the substrate. A second gap is formed between the second lens material and the second surface of the substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A-1D are perspective, frontal views of a waveguide, according to embodiments.

FIGS. 2A-2C are perspective, cross-sectional views of a waveguide, according to embodiments.

FIG. 3 is a flow diagram describing a method of forming a waveguide, according to embodiments

FIGS. 4A-4D are cross-section views showing a waveguide during a method of the waveguide, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to augmented reality (AR) displays. More specifically, embodiments described herein relate to AR waveguides with attached prescription lenses. Eye-pieces to be used for AR contain AR displays using waveguides. Users that use prescription lenses to see normally will require prescription lenses in the eye-pieces. The described methods reduce the complexity of the manufacturing process of the AR waveguides with attached prescription lenses. The methods can also improve the throughput, therefore reducing the cost of the process.

The present disclosure provides AR displays having enhanced adhesive compositions to maintain an air gap between the prescription lens and the substrate, thereby improving clarity of the AR display. The adhesive compositions can be dispensed according to a plurality of dispensing processes, e.g., dispensing, screen printing, inkjet printing, transfer printing, or a combination thereof, thereby allowing for enhanced accuracy during manufacturing to improve clarity and allow for increased customization during AR display fabrication. Additionally, the adhesive compositions can include one or more high optical density materials to further improve device clarity. Moreover, the adhesive compositions can include a visible light compatible photoinitiator to allow for UV curing, thereby improving throughput and reducing manufacturing costs.

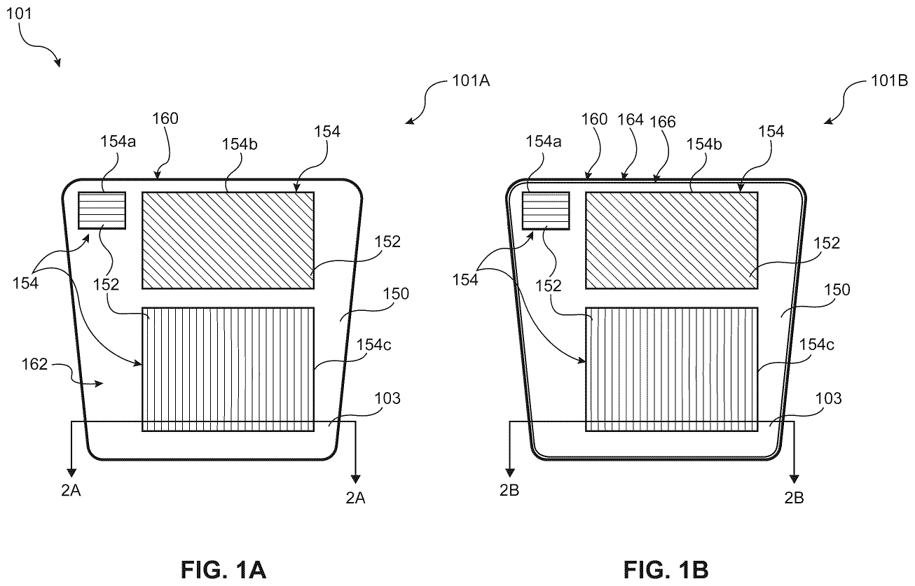

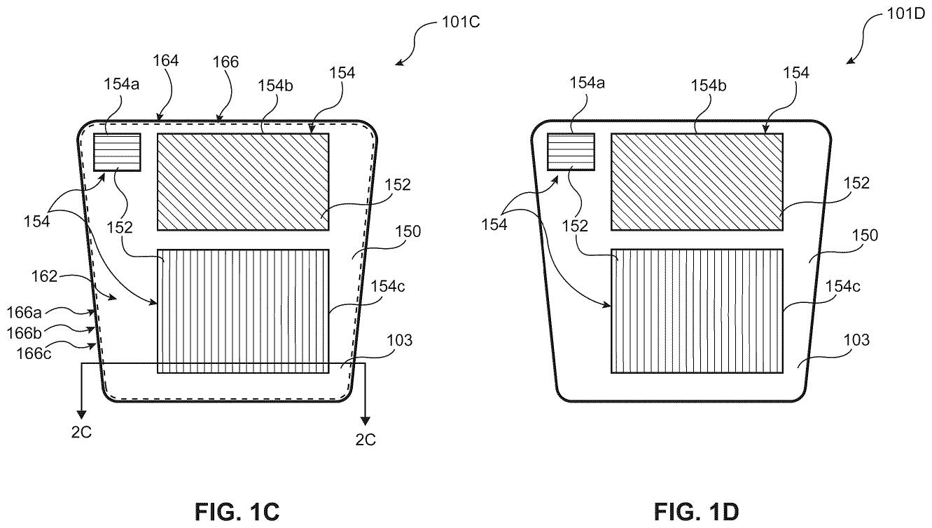

FIG. 1A is a perspective, frontal view of a waveguide 101A. It is to be understood that the waveguide 101A described herein is an exemplary waveguide and that other waveguides may be used with or modified to accomplish aspects of the present disclosure. The waveguide 101A includes a plurality of structures 152. The structures 152 may be disposed over, under, or on a first surface 103 of a substrate 150, or disposed in the substrate 150. The structures 152 are nanostructures and have a sub-micron critical dimension, e.g., a width less than 1 micrometer. Regions of the structures 152 correspond to one or more gratings 154. In one embodiment, which can be combined with other embodiments described herein, the waveguide 101 includes at least a first grating 154a corresponding to an input coupling grating and a third grating 154c corresponding to an output coupling grating. In another embodiment, which can be combined with other embodiments described herein, the waveguide 101A further includes a second grating 154b. The second grating 154b corresponds to a pupil expansion grating or a fold grating.

The substrate 150 can be any substrate used in the art, and can be either opaque or transparent to a chosen wavelength of light, depending on the use of the substrate 150 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 150 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof.

In other embodiments, which can be combined with other embodiments described herein, the substrate 150 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 150 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd2O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K2O), phosphorus pentoxide (P₂O₅), calcium oxide (CaO), or combinations thereof. The substrate 150 may have a refractive index greater than about 1.8. For example, the substrate 150 includes lithium niobate.

The structures 152 include a structure material. The structure material and the substrate 150 include a different material. The structure material includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the structure material include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

In operation of the waveguide 101A, a virtual image is projected from a near-eye display, such as a microdisplay, to the first grating 154a. The structures 152 of the first grating 154a in-couple the incident beams of light of the virtual image and diffract the incident beams to the second grating 154b. The diffracted beams undergo total-internal-reflection (TIR) through the waveguide 101A until the diffracted beams come in contact with structures 152 of the second grating 154b. The diffracted beams from the first grating 154a incident on the second grating 154b are split into a first portion of beams refracted back or lost in the waveguide 101A, a second portion beams that undergo TIR in the second grating 154b until the second portion beams contact another structure of the plurality of structures 152 of the second grating 154b, and a third portion of beams that are transmitted through the waveguide 101A to the third grating 154c. The beams of the second portion of beams that undergo TIR in the second grating 154b continue to contact structures of the plurality of structures 152 until either the intensity of the second portion of beams coupled through the waveguide 101A to the second grating 154b is depleted, or remaining portion of the second portion of beams propagating through the second grating 154b reach the end of the second grating 154b.

The beams pass through the waveguide 101A to the third grating 154c and undergo TIR in the waveguide 101A until the beams contact a structure of the plurality of gratings 154 of the third grating 154c. The beams are split into beams that are refracted back or lost in the waveguide 101A. Beams undergo TIR in the third grating 154c until the beams contact another structure of the plurality of gratings 154 or the beams are out-coupled from the waveguide 101A. The beams that undergo TIR in the third grating 154c continue to contact structures of the plurality of gratings 154 until either the intensity of the beams pass through the waveguide 101A to the third grating 154c is depleted, or a remaining portion of the beams propagating through the third grating 154c have reached the end of the third grating 154c. The beams of the virtual image are propagated from the third grating 154c to overlay the virtual image over the ambient environment.

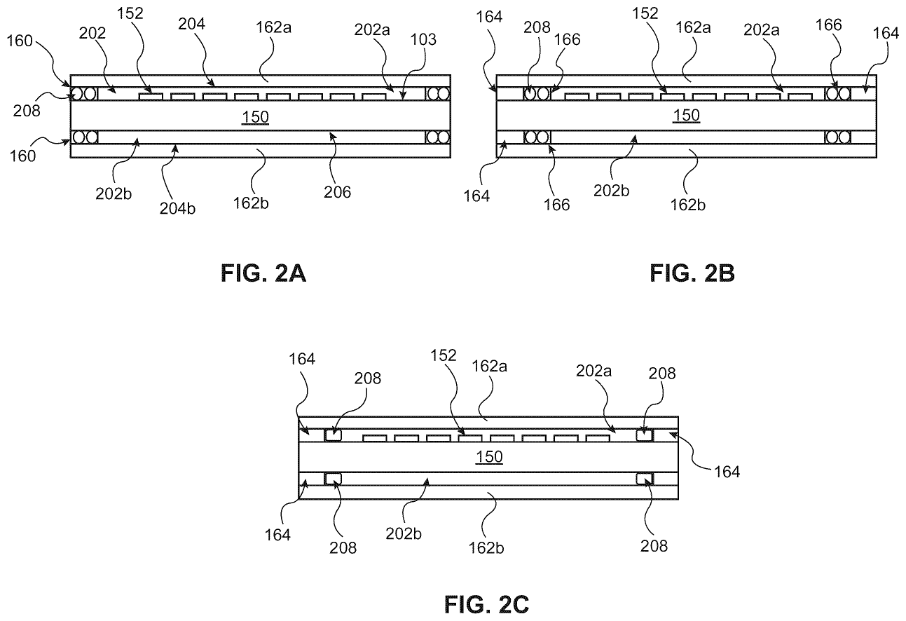

The waveguide 101A includes at least an adhesive composition 160 disposed along at least a portion of a lateral edge of the waveguide. The adhesive composition 160 is configured to secure a lens material 162, to the substrate 150, as described below, with reference to FIGS. 2A-2C.

In some embodiments, a waveguide 101B includes at least a first adhesive composition 164 and a second adhesive composition 166 disposed along at least a portion of a lateral edge of the waveguide, as shown in FIG. 1B. The second adhesive composition 166 may be disposed along an interior surface of the first adhesive composition 164. The second adhesive composition 166 may be disposed along an outer surface of the first adhesive composition. While only two adhesive compositions are shown in FIG. 1B, any number of adhesive compositions and/or layering patterns may be used to couple the lens material 162 to the substrate 150. In some embodiments, the first adhesive composition 164 includes one or more of an acryl-based adhesive, a urethane-based adhesive, and/or an epoxy-based adhesive, and the second adhesive composition 166 independently includes one or more of an acryl-based adhesive, a urethane-based adhesive, and/or an epoxy-based adhesive. For example, the first adhesive composition 164 may be the same as the second adhesive composition 166. As a further example, the first adhesive composition 164 may be different from the second adhesive composition 166.

In some embodiments, a waveguide 101C includes the first adhesive composition 164 disposed along the lateral edge of the substrate 150, and the second adhesive composition 166, in which the second adhesive composition 166 is disposed in a segmented and/or dashed pattern, as shown in FIG. 1C. For example, the second adhesive composition 166 can include a plurality of sub-portions, e.g., a first sub-portion 166a, a second sub-portion 166b, and/or a third sub-portion 166c, dispersed along the interior surface of the first adhesive composition 164. The plurality of sub-portions may be dispersed such that a gap between each sub-portion of the plurality of sub-portions is equal. The plurality of sub-portions may be dispersed such that a gap between each sub-portion of the plurality of sub-portions is different.

In some embodiments, a waveguide 101D includes the adhesive composition 160 disposed along at least a first portion of the lateral edge of the substrate 150, in which at least a second portion of the lateral edge of the substrate 150 does not have the adhesive composition 160, as shown in FIG. 1D. Without being bound by theory, by omitting the adhesive composition from at least a second portion of the lateral edge of the substrate, the waveguide 101D may retained by a plurality of AR and/or VR devices. For example, the waveguide 101D may be retained in an AR and/or VR device by grasping and/or retaining the waveguide 101D at the second portion of the lateral edge of the substrate 150. Additionally, and without being bound by theory, by omitting the adhesive composition from at least a second portion of the lateral edge of the substrate, a pressure that would otherwise build up within an air gap between the lens material 162 and the substrate 150 may be reduced or eliminated.

As shown in FIG. 2A, a first lens material 162a is disposed over the substrate 150 to produce an air gap 202, e.g., a first gap 202a. The lens material can include a cover glass, a push-pull material, a prescription lens, and/or a dimming module. The first lens material 162a can include a plastic material and/or a glass material. For example, the first lens material 162a can include a UV-curable acrylate, a UV-curable epoxy, a UV-curable silicone, a UV-curable thiolene, or combinations thereof. The first lens material 162a is disposed over the first surface 103 of the substrate 150. The first gap 202a is defined by the first lower surface 204 of the first lens material 162a and the first surface 103 of the substrate 150.

A second surface 206 is opposite the first surface 103. A second lens material 162b is disposed over the second surface 206 of the substrate 150 to produce a second gap 202b. The second lens material 162b can include a cover glass, a push-pull material, a prescription lens, and/or a dimming module. The second lens material 162b can include a plastic material and/or a glass material. For example, the second lens material 162b can include a UV-curable acrylate, a UV-curable epoxy, a UV-curable silicone, a UV-curable thiolene, or combinations thereof. The second lens material 162b is disposed over the second surface 206 of the substrate 150. The second gap 202b is defined by the first upper surface 204b of the second lens material 162b and the second surface 206 of the substrate 150.

In an embodiment, the first lens material 162a faces a world side of the resulting AR display, i.e., the side away from the user. The second lens material 162b faces the eye side of the resulting AR display, i.e., the side facing the user's eye. The first lens material 162a and/or the second lens material 162b provides the correction to the user in the way a traditional corrective prescription lens behaves. In some embodiments, the first lens material 162a and/or the second lens material 162b can be an eye piece without a prescription lens. For a user not needing prescription lenses, the first lens material 162a may have a prescription of −2 diopter, and the second lens material 162b may have a prescription lens of +2 diopter, combined for an eye-piece with no correction of the users vision. For users with myopia, the first lens material 162a may have a prescription of −2 diopter, and the second lens material 162b may have a prescription lens of +1 diopter, combined to provide −1 diopter optical power for eye-sight correction.

The first gap 202a includes air. Air has a refractive index of about 1.0. The first gap 202a optically isolates the substrate 150 from the first lens material 162a. The optical isolation of the substrate 150 and the first lens material 162a is caused by the first gap 202a having a lower refractive index compared to the substrate 150 and the first lens material 162a. The substrate 150 and first lens material 162a are optically isolated in order for the waveguide 101 to function properly. The second gap 202b includes air. The second gap 202b optically isolates the substrate 150 from the second lens material 162b. The optical isolation of the substrate 150 and the second lens material 162b is caused by the second gap 202b having a lower refractive index compared to the substrate and the second lens material 162b. The substrate 150 and the second lens material 162b are optically isolated in order for the waveguide 101 to function properly.

The first lens material 162a and second lens material 162b are disposed over the substrate 150 using an adhesive composition 160. The adhesive composition 160 includes one or more of an acryl-based adhesive, a urethane-based adhesive, and/or an epoxy-based adhesive. For example, the adhesive composition 160 can include one or more monomers, crosslinkers, and/or oligomers suitable to adhere the first lens material 162a and/or the second lens material 162b to the substrate 150.

The adhesive composition 160 includes an absorption material. The absorption material can include one or more blacking inks, one or more siloxane-containing resins, one or more dyes, one or more pigments, a polymer mix of one or more binders, or a combination thereof. In an embodiment, the absorption material can include one or more types of particles, at least one of one or more dyes or one or more pigments, or a polymer matrix of one or more binders or embedded in the adhesive composition 160. In some embodiments, the one or more types of particles, one or more dyes, one or more pigments can include a particle size of about 5 nm to about 500 μm. In some embodiments, the absorption material can include one or more filler dispersions, one or more photoinitiators, one or more epoxy resins, one or more additives, one or more silanes, one or more isocyanates, one or more acids, one or more phosphine oxides, or combinations thereof. Examples of the filler dispersions include acrylates or methacrylates. Examples of the additives include amines or amides. Examples of the dyes include organic dyes. The one or more pigments may include, but are not limited to, carbon black, carbon nanotubes, iron oxide black, black pigments, or combinations thereof. The one or more binders may be operable to be cured by radiation, to form a polymer matrix. The one or more types of particles may be disposed in the polymer matrix. The one or more binders may include, but are not limited to, a UV curable binder, a LED curable binder, a thermal curable binder, an infrared curable binder, or combinations thereof. The one or more photoinitiators can include a photo sensitizer and/or a blue absorbing photoinitiator such as camphorquinone. Without being bound by theory, a photoinitiator can improve a curing depth of the adhesive composition.

The one or more types of particles may include, but are not limited to, titanium, titanium oxide (TiO₂), chromium, Si, zirconium oxide (ZrO₂), zinc oxide (ZnO), ferrosoferric oxide (Fe₃O₄), germanium (Ge), SiC, diamond, dopants thereof, or any combination thereof. The one or more types of particles may include at least of nanoparticles or microparticles. Each nanoparticle (NP) or microparticle (MP) can be a coated particle, such as one, two, or more shells disposed around a core. In some examples, the NPs or MPs can contain one or more types of ligands coupled to the outer surface of the NPs or MPs (e.g., ligated NPs or stabilized NPs). The NPs or MPs can have one or more different shapes or geometries, such as spherical, oval, rod, cubical, wire, cylindrical, rectangular, or combinations thereof. The NPs can have a size or a diameter of about 2 nm to about 1000 nm. The MPs can have a size or a diameter of about 1 μm to about 500 μm.

A particle refractive index of the one or more types of particles is greater than 2.0. In some embodiments, which can be combined with other embodiments described herein, the particle refractive index of the one or more types of particles is about 2.4 or greater. In some embodiments, the particle refractive index greater than 2.0 may provide the adhesive composition 160 to have a refractive index of about 1.7 or greater. The optical density of the adhesive composition 160 of about 2.0 or greater is provided by the at least one of one or more dyes or one or more pigments. The refractive index of about 1.7 or greater of the adhesive composition 160 is matched to high refractive index substrates, e.g., the substrate 150 having a refractive index greater than about 1.8.

The adhesive composition 160 can include one or more thixotropy index modifiers, e.g., fumed silica and/or carbon black. The adhesive composition 160 includes about 0.001 wt % to about 50 wt %, such as about 1 wt % of the one or more thixotropy index modifiers. Without being bound by theory, the one or more thixotropy index modifiers can allow for enhanced dispensing of the adhesive composition on the substrate 150. The adhesive composition 160 has a thixotropy index of about 1.5 to about 2000, such as about 10. The adhesive composition 160 can include one or more surface energy modifiers, e.g., a silicone based surfactant, a fluorinated surfactant, or a pluronic surfactant. The adhesive composition 160 includes about 0.001 wt % to about 5 wt %, such as about 0.1 wt % of the one or more surface energy modifiers. Without being bound by theory, the one or more surface energy modifiers can allow for a controlled rate of flow on the substrate 150 after dispensing the adhesive composition. The adhesive composition 160 has a surface tension of about 20 mN/m to about 70 mN/m, such as about 35 mN/m. The adhesive composition 160 can include one or more adhesion promoters, e.g., polyacrylic acid, functionalized silanols, functionalized epoxy, functionalized amine, functionalized thiols, and metal salts, such as titanium alcoxide. The adhesive composition 160 includes about 0.01 wt % to about 10 wt %, such as about 1 wt % of the one or more adhesion promoters. Without being bound by theory, the one or more adhesion promoters can allow for enhanced adhesion between the first lens material 162a and/or the second lens material 162b to the substrate.

At least a spacer 208 is disposed between the first lens material 162a and the first surface 103 of the substrate 150, and between the second lens material 162b and the second surface 206 of the substrate 150. The spacer 208 can include polymer, e.g., a polystyrene divinylbenzene or polymethylacrylate. The spacer 208 can include glass, e.g., a soda lime. The spacer 208 can include a size and/or diameter of about 500 nm to about 1 mm. In some embodiments, the spacer 208 is opaque, e.g., not transparent. In some embodiments, the spacer 208 is hollow and/or has a cavity within a portion of the spacer 208.

In some embodiments, the spacer 208 can be disposed within the first adhesive composition 164 and/or the second adhesive composition 166, as shown in FIG. 2B. While FIG. 2B only shows spacers 208 disposed in the second adhesive composition 166, the spacers 208 can be disposed in the first adhesive composition 164, or disposed in the first adhesive composition 164 and the second adhesive composition 166.

In some embodiments, the spacer 208 be a cured acryl-based adhesive, a cured urethane-based adhesive, and/or a cured epoxy-based adhesive that extends between the substrate 150 and the first lens material 162a or the second lens material 162b, as shown in FIG. 2C. For example, the spacer 208 can be formed from an adhesive composition 160, e.g., the first adhesive compositions 164 and/or the second adhesive composition 166, that is cured prior to disposing the first lens material 162a or the second lens material 162b over the substrate 150. In this example, the spacer 208 would include the cured first adhesive compositions 164 or the cured second adhesive composition 166.

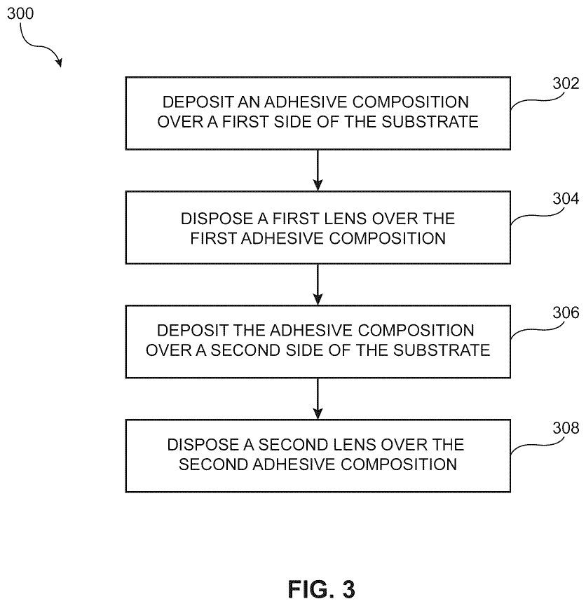

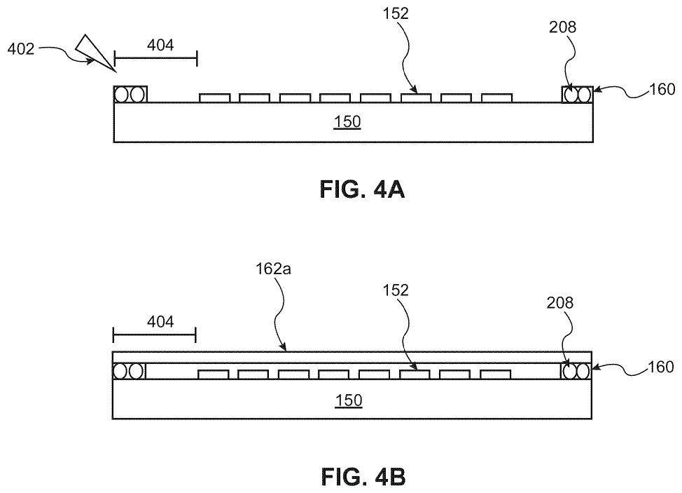

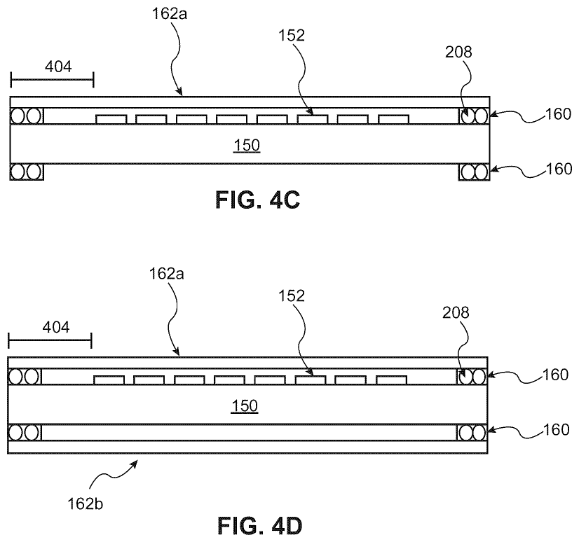

FIG. 3 is a flow diagram describing a method 300 of forming the waveguide 101A. FIGS. 4A-4D are cross-sectional views showing a substrate 150 during the method 300 of forming the waveguide 101A.

At operation 302, as shown in FIG. 4A, an adhesive composition 160 is deposited over a first surface 103 of the substrate 150. The adhesive composition 160 can be disposed over the first surface 103 of the substrate 150 using a dispenser 402 according to one or more dispensing processes, e.g., needle dispensing, screen printing, inject printing, and/or transfer printing. In one or more embodiment, during a needle dispensing process, a needle dispensing pressure is about 20 psi. The needle gauge is about 25. The needle speed is about 1 mm/s. In one or more embodiments, during a screen printing process, a down force of about 70 N is applied to a 325 mesh screen. In one or more embodiments, during an inkjet printing process, a voltage of about 5 volts to about 15 volts is applied to an inkjet printer. The inkjet printer has a deposition frequency of about 1000 Hz. The dispensing process has a processing temperature of about 15 degrees Celsius to about 30 degrees Celsius. In some embodiments, depositing the adhesive composition 160 can include depositing the adhesive composition 160 over one or more lateral edges and/or non-grating areas 404 of the substrate 150. For example, a non-grating area 404 of the substrate 150 can include an area where no structures 152 are present on and/or in the substrate 150. In some embodiments, the spacers 208 are suspended and/or immersed within the adhesive composition 160, in which depositing the adhesive composition 160 includes dispensing the spacers 208 over the substrate 150.

At operation 304, as shown in FIG. 4B, a first lens material 162a is deposited over a first surface 103 of the substrate 150, in which the first lens material 162a contacts the adhesive composition 160. The first lens material 162a is separated from the first surface 103 by a first gap 202a. The first gap 202a allows for optical independence between the first lens material 162a and the substrate. In some embodiments, a thickness of the first gap 202a is the same as the thickness of the spacer 208 in the adhesive composition 160. Without being bound by theory, a first lens material 162a deposited over a first surface 103 of the substrate 150 by contacting the adhesive composition 160 can allow for improved adhesion, thereby increasing robustness of the waveguide and/or AR device.

At operation 306, operation 302 is repeated on a second surface 206 of the substrate 150. The substrate 150 is flipped over to expose the second surface 206. The second surface 206 is opposite the first surface 103 of the substrate 150. FIG. 4C illustrates the second surface 206 of the substrate 150. An adhesive composition 160 is deposited over the second surface 206 of the substrate 150. The adhesive composition 160 can be disposed over the second surface 206 of the substrate 150 using the dispenser 402 according to one or more dispensing processes, e.g., needle dispensing, screen printing, inject printing, and/or transfer printing. In one or more embodiment, during a needle dispensing process, a needle dispensing pressure is about 20 psi. The needle gauge is about 25. The needle speed is about 1 mm/s. In one or more embodiments, during a screen printing process, a down force of about 70 N is applied to a 325 mesh screen. In one or more embodiments, during an inkjet printing process, a voltage of about 5 volts to about 15 volts is applied to an inkjet printer. The inkjet printer has a deposition frequency of about 1000 Hz. The dispensing process has a processing temperature of about 15 degrees Celsius to about 30 degrees Celsius. In some embodiments, depositing the adhesive composition 160 can include depositing the adhesive composition 160 over one or more lateral edges and/or non-grating areas 404 of the substrate 150. For example, a non-grating area 404 of the substrate 150 can include an area where no gratings 102 are present on and/or in the substrate 150. In some embodiments, the spacers 208 are suspended and/or immersed within the adhesive composition 160, in which depositing the adhesive composition 160 includes dispensing the spacers 208 over the substrate 150.

At operation 308, a second lens material 162b is deposited over the second surface 206 103 of the substrate 150, in which the second lens material 162b contacts the adhesive composition 160. FIG. 4D illustrates the second lens material 162b as being separated from the second surface 206 by the second gap 202b. The second gap 202b allows for optical independence between the second lens material 162b and the substrate. In some embodiments, a thickness of the second gap 202b is the same as the thickness of the spacer 208 in the adhesive composition 160. Without being bound by theory, depositing a second lens material 162b over a second surface 206 of the substrate 150 by contacting the adhesive composition 160 can improve adhesion, thereby increasing robustness of the waveguide and/or AR device.

In summation, the present disclosure generally relates to augmented reality (AR) displays. More specifically, embodiments described herein relate to AR displays with attached prescription lens. The AR displays have enhanced adhesive compositions to maintain an air gap between the prescription lens and the substrate, thereby improving clarity of the AR display. The adhesive compositions can be dispensed according to a plurality of dispensing processes, e.g., dispensing, screen printing, inkjet printing, transfer printing, or a combination thereof, thereby allowing for enhanced accuracy during manufacturing to improve clarity and allow for increased customization during AR display fabrication. Additionally, the adhesive compositions can include one or more high optical density materials to further improve device clarity. Moreover, the adhesive compositions can include a visible light compatible photoinitiator to allow for UV curing, thereby improving throughput and reducing manufacturing costs.

While the foregoing is directed to embodiments of the present disclosure, other and further embodiments of the disclosure may be devised without departing from the basic scope thereof, and the scope thereof is determined by the claims that follow.

What is claimed is:

1. A display, comprising:
a waveguide, the waveguide comprising a substrate with a first surface and a second surface, at least one grating being disposed over the first surface or the second surface;
a first lens material disposed over the first surface of the substrate;
a first gap defined by a lower surface of the first lens material and the first surface of the substrate;
a second lens material disposed over the second surface of the substrate;
a second gap defined by an upper surface of the second lens material and the second surface of the substrate; and
an adhesive composition comprising at least a spacer, wherein the adhesive composition is disposed between:
the first lens material and the first surface of the substrate, and
the second lens material and the second surface of the substrate.

2. The display of claim 1, wherein the first gap and the second gap comprise air.

3. The display of claim 1, wherein the spacer comprises a polymer or glass.

4. The display of claim 1, wherein the spacer comprises polystyrene divinylbenzene or polymethylacrylate.

5. The display of claim 1, wherein the spacer comprises a diameter of about 500 nm to about 1 mm.

6. The display of claim 1, wherein the adhesive composition comprises an absorption material having a refractive index of greater than 2.0.

7. The display of claim 1, wherein the adhesive composition comprises a photoinitiator.

8. The display of claim 1, wherein the adhesive composition comprises a thixotropy index modifier, wherein the thixotropy index modifier comprises fumed silica or carbon black.

9. The display of claim 1, wherein the adhesive composition comprises a surface energy modifier, wherein the surface energy modifier comprises a silicone based surfactant, a fluorinated surfactant, or a pluronic surfactant.

10. A display, comprising:
a waveguide, the waveguide comprising a substrate with a first surface and a second surface, at least one grating being disposed over the first surface or the second surface;
a first lens material disposed over the first surface of the substrate;
a first gap defined by a lower surface of the first lens material and the first surface of the substrate;
a second lens material disposed over the second surface of the substrate;
a second gap defined by an upper surface of the second lens material and the second surface of the substrate; and
a first adhesive composition and a second adhesive composition disposed between the first lens material and the first surface of the substrate.

11. The display of claim 10, wherein the first adhesive composition comprises a first spacer.

12. The display of claim 11, wherein the second adhesive composition comprises a second spacer.

13. The display of claim 10, wherein the first gap and the second gap comprise air.

14. The display of claim 10, wherein the first adhesive composition or the second adhesive composition comprises an absorption material having a refractive index of greater than 2.0.

15. The display of claim 10, wherein the first adhesive composition or the second adhesive composition comprises a photoinitiator.

16. The display of claim 10, wherein the first adhesive composition or the second adhesive composition comprises a thixotropy index modifier, wherein the thixotropy index modifier comprises fumed silica or carbon black.

17. The display of claim 10, wherein the first adhesive composition or the second adhesive composition comprises a surface energy modifier, wherein the surface energy modifier comprises a silicone based surfactant, a fluorinated surfactant, or a pluronic surfactant.

18. A method for forming a display, comprising:
depositing an adhesive composition over a first surface of a substrate of a waveguide, wherein the adhesive composition comprises at least a spacer;
coupling a first lens material to the adhesive composition on the first surface of the substrate, wherein a first gap is formed between the first lens material and the first surface of the substrate;
depositing a second adhesive composition over a second surface of the substrate of the waveguide; and
coupling a second lens material to the adhesive composition on the second surface of the substrate, wherein a second gap is formed between the second lens material and the second surface of the substrate.

19. The method of claim 18, wherein depositing the adhesive composition over the first surface of the substrate comprises dispensing, screen printing, inkjet printing, or transfer printing the adhesive composition.

20. The method of claim 19, wherein the adhesive composition is deposited over a non-grating area of the substrate of the waveguide.
